(19) United States
(12) Patent Application Publication
(10) Pub. No.: US 2006/0020823 A1
(43) Pub. Date: Jan. 26, 2006

(54) Data protecting apparatus and data protecting method

(75) Inventor: Shigeru Morino, Numazu-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/886,599

(22) Filed: Jul. 9, 2004

(51) Int. Cl. G06F 12/14

(52) U.S. Cl. 713/193

(57) ABSTRACT

After power-on of an MFP, a data protecting apparatus receives an encryption key from a host server via a network I/F, stores the received encryption key in an encryption key storage unit, delivers the encryption key to a decryption key generation unit, and stores a generated decryption key in a decryption key storage unit. Subsequently, an HDD controller reads out master data that is written in an HDD. A data decryption unit decrypts the master data, using the decryption key stored in the decryption key storage unit. A REF data generation unit generates reference data. A data comparator compares the decrypted master data with the generated reference data. If the decrypted master data coincides with the reference data, the data protecting apparatus determines that the encryption key is normal. If they do not coincide, the data protecting apparatus determines that the encryption key is abnormal.

### BACKGROUND OF THE INVENTION

1. Field of the Invention

The present invention relates to a data protecting apparatus and a data protecting method, wherein plain (unencrypted) data, which is input from outside, is encrypted and stored in a hard disk drive and, reversely, encrypted data stored in the hard disk drive is read out and decrypted and the resultant plain data is output to the outside.

2. Description of the Related Art

In the prior art, there are known a data protecting apparatus and a data protecting method, which are put to practical use, wherein plain data, which is input from outside, is encrypted and stored in a hard disk drive and, reversely, encrypted data stored in the hard disk drive is read out and decrypted and the resultant plain data is output to the outside.

Jpn. Pat. Appln. KOKAI Publication No. 11-15738, for instance, discloses a technique relating to a data storage apparatus with an encryption function. This technique comprises recording medium drive means that includes a storage unit that stores data and a removable recording medium that stores an encryption key and a decryption key.

With this structure, when the operation of the system is finished, plain data is read out of the storage unit by a process finishing instruction, the data is encrypted using an encryption key, and the encrypted data is rewritten back to the storage unit. At the same time, a decryption key corresponding to the encryption key is output to the removable recording medium, following which the plain data in the storage unit is erased.

On the other hand, when the system is started, the decryption key is read out of the removable recording medium, and the encrypted data that is read out of the storage unit is decrypted. The resultant plain data is written back to the storage unit. Then, the encrypted data in the storage unit is erased. Further, while the system is being in operation, data in plain format is present in the storage unit, and the data is directly read and written without encryption/decryption.

For example, data is stored in a hard disk drive that serves as a storage unit (storage means) in a digital multi-function peripheral (MFP). In this case, there is such a problem that the data in the hard disk drive may be read out due to a theft of the hard disk drive itself.

Even in such a case, if the data stored in the hard disk drive is encrypted, the data cannot be read out.

With this structure, however, whether the decryption key is correct or incorrect is not determined. Consequently, if an error is included in the decryption key, the encrypted data cannot correctly be decrypted.

In the above-described example, although a method of generating an encryption key is not shown, if an error is included in the encryption key, erroneously encrypted data is written in the storage unit. In this case, even if the encrypted data is to be decrypted later using a correct key, the encrypted data cannot correctly be decrypted. If it is not understood what error is included in the encryption key, the encrypted data can never be used.

Possible factors that cause an error in decryption include an external disturbance on a transmission path at a time of storing/reading out data in/from a recording medium, and damage to the recording medium itself.

### BRIEF SUMMARY OF THE INVENTION

The object of an aspect of the present invention is to provide a data protecting apparatus and a data protecting method, which can protect data by correctly encrypting and decrypting data that is to be stored in a hard disk drive.

According to an aspect of the present invention, there is provided a data protecting apparatus that encrypts and decrypts data, comprising: reception means for receiving, when the data protecting apparatus is powered on, encryption key information that is transmitted; first storage means for storing the encryption key information that is received by the reception means; first generation means for generating decryption key information on the basis of the encryption key information that is stored in the first storage means; second storage means for storing the decryption key information that is generated by the first generation means; storing means for storing master data in advance, which is obtained by encrypting reference data; decryption means for decrypting the master data, which is stored in the storing means, using the decryption key information stored in the second storage means; second generation means for generating reference data; comparison means for comparing the reference data, which is generated by the second generation means, with the master data that is decrypted by the decryption means; and determination means for determining, on the basis of a comparison result of the comparison means, whether the encryption key information, which is received by the reception means, is normal or not.

According to another aspect of the present invention, there is provided a data protecting method for a data protecting apparatus that encrypts and decrypts data, comprising: receiving, when the data protecting apparatus is powered on, encryption key information that is transmitted; storing the received encryption key information; generating decryption key information on the basis of the stored encryption key information; storing the generated decryption key information; decrypting prestored master data that is obtained by encrypting reference data, using the stored decryption key information; generating reference data; comparing the generated reference data with the decrypted master data; and determining, on the basis of a result of the comparison, whether the received encryption key information is normal or not.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 shows a system configuration of a digital multi-function peripheral (MFP) according to the present invention;

FIG. 2 is a block diagram showing an internal structure of the MFP according to the invention;

FIG. 3 is a flow chart illustrating a determination operation for determining whether an encryption key in a data protecting apparatus in the MFP is normal or abnormal; and

FIG. 4 is a flow chart illustrating another determination operation for determining whether an encryption key in the data protecting apparatus in the MFP is normal or abnormal.

### DETAILED DESCRIPTION OF THE INVENTION

An embodiment of the present invention will now be described with reference to the accompanying drawings.

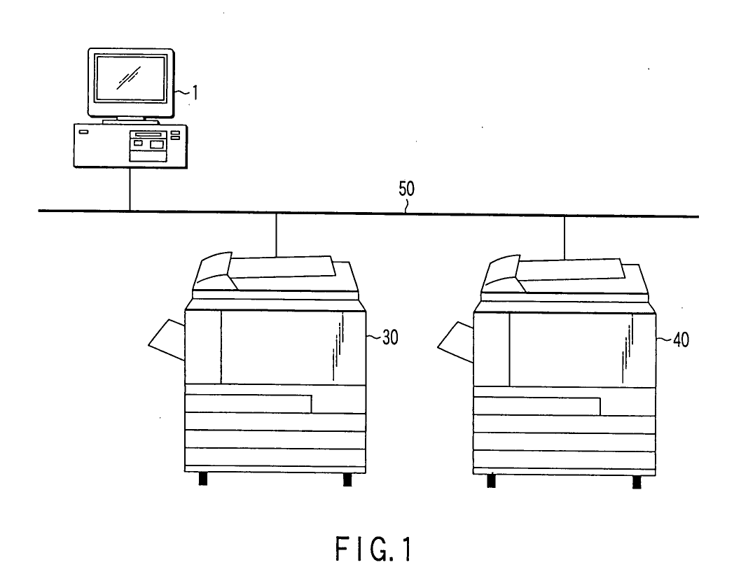

FIG. 1 shows a system configuration of a digital multi-function peripheral (MFP) according to the present invention. A host server 1 is connected to digital multi-function peripherals (MFP) 30 and 40 over a network 50.

The host server 1 thus provides the MFP 30, 40 with solutions such as collection of various information and update of software.

Since the MFP is expensive, the MFP is often installed on a rental basis. In this case, the host server 1 executes, e.g. a license authentication procedure and a charging management procedure that is based on the number of copies.

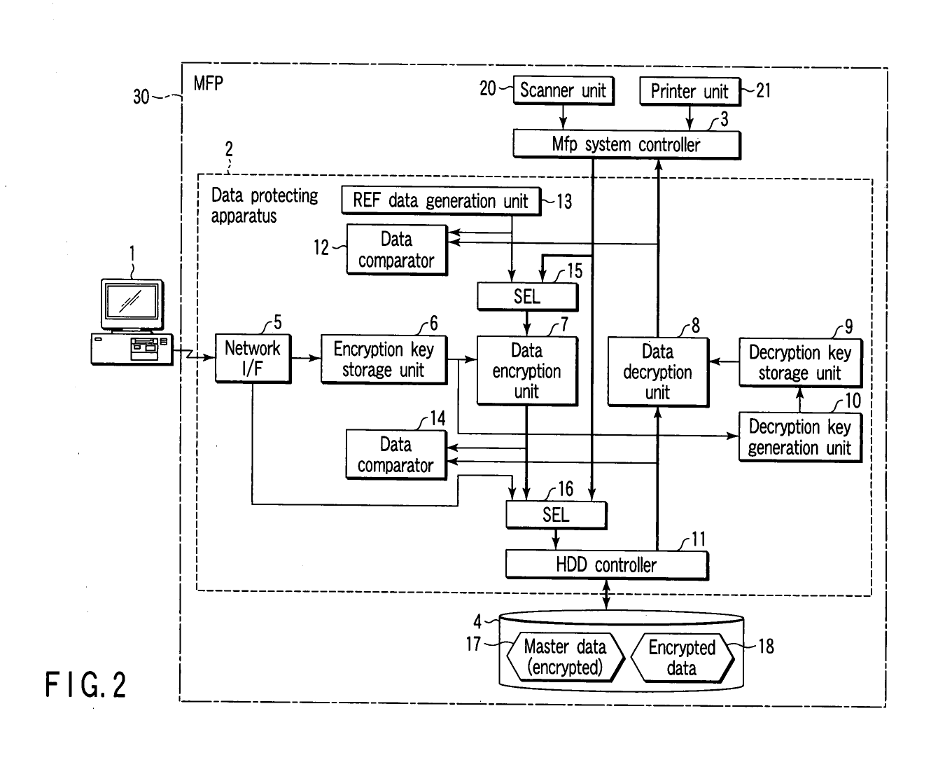

FIG. 2 shows an internal structure of the MFP 30 according to the invention. The MFP 40 has the same internal structure as the MFP 30. The MFP 30 is thus described representatively.

The MFP 30 comprises a data protecting apparatus 2, an MFP system controller 3, a hard disk drive (HDD: storing means) 4, a scanner unit 20 and a printer unit 21.

The data protecting apparatus 2 is described.

The data protecting apparatus 2 is connected to the host server 1 over the network 50.

The data protecting apparatus 2 includes a network interface (I/F: reception means) 5, an encryption key storage unit 6, a data encryption unit 7, a data decryption unit 8, a decryption key storage unit (storage means) 9, a decryption key generation unit (generation means) 10, an HDD controller 11, a data comparator (comparison means) 12, a reference (REF) data generation unit (generation means) 13, a data comparator (comparison means) 14, and selectors (SEL) 15 and 16.

The encryption key storage unit 6 comprises a volatile memory, in which data is lost upon power-off. The encryption key storage unit 6 requires communication of a key each time power is turned on.

The data protecting apparatus 2 is configured such that the entirety thereof is built in a single LSI chip. This eliminates the possibility of leakage of reference data itself, which is generated by the REF data generation unit 13.

An encryption operation that is executed between the host server 1 and the MFP 30 with the above-described structure will now be described.

Prior to starting the encryption operation, master data (encrypted) needs to be stored in the HDD 4 in the MFP 30.

The host server 1 generates master data (encrypted) by a software process and sends it to the MFP 30 over the network 50. Specifically, the host server 1 encrypts reference data, which serves as a reference, using an encryption key (encryption key information), thereby generating master data (encrypted). The master data (encrypted), which is transmitted to the MFP 30, is written in the HDD 4 via the network I/F 5, selector 16 and HDD controller 11 in the data protecting apparatus 2.

The preparatory procedure is thus completed.

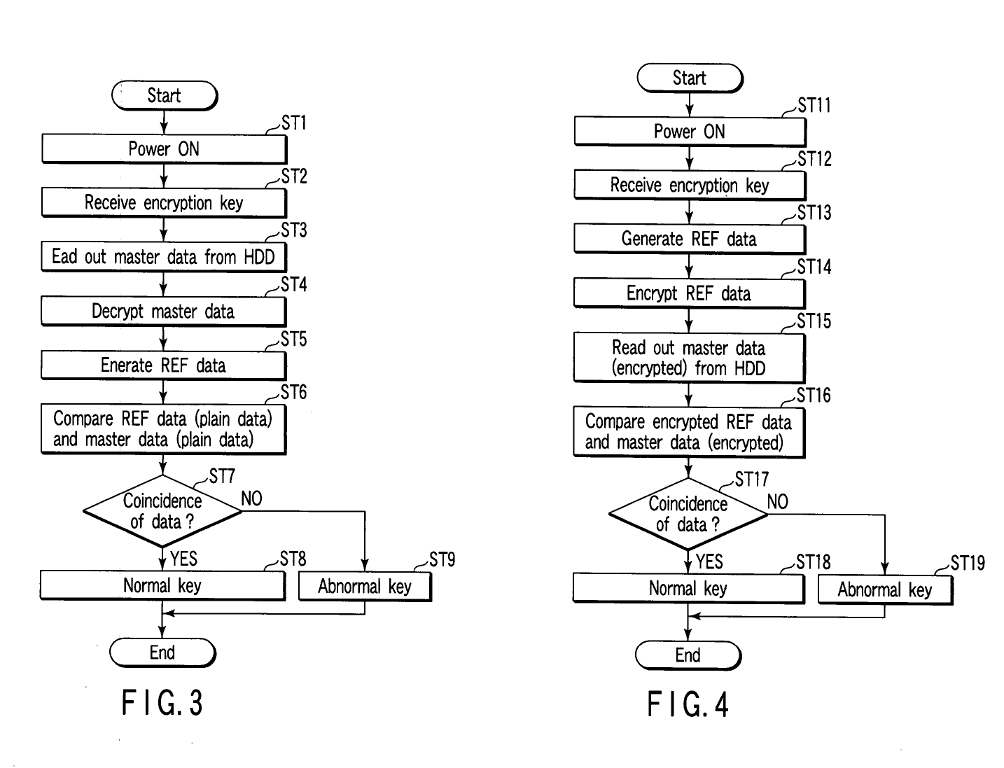

Now referring to a flow chart of FIG. 3, a description is given of a determination operation for determining whether an encryption key in the data protecting apparatus 2 in the MFP 30 is normal or abnormal.

After power-on of the MFP 30 (ST1), the data protecting apparatus 2 receives an encryption key that is transmitted from the host server 1 via the network I/F 5 (ST2). In this case, the data protecting apparatus 2 stores the received encryption key in the encryption key storage unit 6 and also delivers the encryption key to the decryption key generation unit 10. The decryption key generation unit 10 generates a decryption key, and the generated decryption key is stored in the decryption key storage unit 9.

Subsequently, the HDD controller 11 reads out the master data that is written in the HDD 4 (ST3).

The data decryption unit 8 decrypts the master data, which is read out in step ST3, using the decryption key that is stored in the decryption key storage unit 9 (ST4).

On the other hand, the REF data generation unit 13 generates reference data (ST5).

The data comparator 12 compares the master data, which is decrypted in step ST4, with the reference data that is generated in step ST5 (ST6).

If the decrypted master data coincides with the reference data, the data protecting apparatus 2 determines that the encryption key is normal (ST7, ST8). If the decrypted master data does not coincide with the reference data, the data protecting apparatus 2 determines that the encryption key is abnormal (ST7, ST9).

Next, referring to a flow chart of FIG. 4, a description is given of another determination operation for determining whether an encryption key in the data protecting apparatus 2 in the MFP 30 is normal or abnormal.

After power-on of the MFP 30 (ST11), the data protecting apparatus 2 receives an encryption key that is transmitted from the host server 1 via the network I/F 5 (ST12). In this case, the data protecting apparatus 2 stores the received encryption key in the encryption key storage unit 6 and also delivers the encryption key to the decryption key generation unit 10. The decryption key generation unit 10 generates a decryption key, and the generated decryption key is stored in the decryption key storage unit 9.

Subsequently, the REF data generation unit 13 generates reference data (ST13). The generated reference data is input to the data encryption unit 7 via the selector 15.

The data encryption unit 7 encrypts the reference data using the encryption key that is stored in the encryption key storage unit 6 (ST14).

On the other hand, the HDD controller 11 reads out the master data that is stored in the HDD 4 (ST15).

The data comparator 14 compares the reference data, which is encrypted in step ST14, with the master data (encrypted) that is read out in step ST15 (ST16).

If the encrypted reference data coincides with the master data, the data protecting apparatus 2 determines that the encryption key is normal (ST17, ST18). If the encrypted reference data does not coincide with the master data, the data protecting apparatus 2 determines that the encryption key is abnormal (ST17, ST19).

The determination operation using the data comparator 12 and the determination operation using the data comparator 14 may be combined.

As has been described above, according to the embodiment of the invention, data that is stored in the hard disk drive can correctly be encrypted and decrypted, and the data can be protected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data protecting apparatus that encrypts and decrypts data, comprising:
reception means for receiving, when the data protecting apparatus is powered on, encryption key information that is transmitted;
first storage means for storing the encryption key information that is received by the reception means;
first generation means for generating decryption key information on the basis of the encryption key information that is stored in the first storage means;
second storage means for storing the decryption key information that is generated by the first generation means;
storing means for storing master data in advance, which is obtained by encrypting reference data;
decryption means for decrypting the master data, which is stored in the storing means, using the decryption key information stored in the second storage means;
second generation means for generating reference data;
comparison means for comparing the reference data, which is generated by the second generation means, with the master data that is decrypted by the decryption means; and
determination means for determining, on the basis of a comparison result of the comparison means, whether the encryption key information, which is received by the reception means, is normal or not.

2. The data protecting apparatus according to claim 1, wherein the reception means receives the encryption key information that is transmitted from a host server over a network.

3. The data protecting apparatus according to claim 1, wherein the first storage means is a volatile memory in which the stored encryption key information is lost upon power-off of the data protecting apparatus.

4. The data protecting apparatus according to claim 1, wherein the storing means stores the master data that is received in advance via the reception means.

5. The data protecting apparatus according to claim 1, wherein the storing means stores, when the reception means receives master data transmitted from a host server via a network, the received master data.

6. A data protecting apparatus that encrypts and decrypts data, comprising:
reception means for receiving, when the data protecting apparatus is powered on, encryption key information that is transmitted;
storage means for storing the encryption key information that is received by the reception means;
generation means for generating reference data;
encryption means for encrypting the reference data, which is generated by the generation means, using the encryption key information that is stored in the storage means;
storing means for storing master data in advance, which is obtained by encrypting reference data;
comparison means for comparing the master data, which is stored in the storing means, with the reference data that is encrypted by the encryption means; and
determination means for determining, on the basis of a comparison result of the comparison means, whether the encryption key information, which is received by the reception means, is normal or not.

7. The data protecting apparatus according to claim 6, wherein the reception means receives the encryption key information that is transmitted from a host server over a network.

8. The data protecting apparatus according to claim 6, wherein the storage means is a volatile memory in which the stored encryption key information is lost upon power-off of the data protecting apparatus.

9. The data protecting apparatus according to claim 6, wherein the storing means stores the master data that is received in advance via the reception means.

10. The data protecting apparatus according to claim 6, wherein the storing means stores, when the reception means receives master data transmitted from a host server via a network, the received master data.

11. A data protecting method for a data protecting apparatus that encrypts and decrypts data, comprising:
receiving, when the data protecting apparatus is powered on, encryption key information that is transmitted;
storing the received encryption key information;
generating decryption key information on the basis of the stored encryption key information;
storing the generated decryption key information;
decrypting prestored master data that is obtained by encrypting reference data, using the stored decryption key information;
generating reference data;
comparing the generated reference data with the decrypted master data; and
determining, on the basis of a result of the comparison, whether the received encryption key information is normal or not.

12. A data protecting method for a data protecting apparatus that encrypts and decrypts data, comprising:
receiving, when the data protecting apparatus is powered on, encryption key information that is transmitted;
storing the received encryption key information;
generating reference data;
encrypting the generated reference data using the stored encryption key information;
comparing prestored master data, which is obtained by encrypting reference data, with the encrypted reference data; and
determining, on the basis of a result of the comparison, whether the received encryption key information is normal or not.
